(19) United States
(12) Patent Application Publication
(10) Pub. No.: US 2026/0308961 A1
(43) Pub. Date: Oct. 8, 2026

(54) HORIZONTAL MOVING MODULE FOR HORIZONTAL MOVING TYPE WINDOWS

(71) Applicant: CS TECH CO., LTD., Cheonan-si (KR)

(72) Inventor: Jae Son LEE, Cheonan-si (KR)

(73) Assignee: CS TECH CO., LTD., Cheonan-si (KR)

(21) Appl. No.: 19/360,877

(22) Filed: Oct. 16, 2025

(30) Foreign Application Priority Data
Apr. 8, 2025 (KR) 10-2025-0045206

(51) Int. Cl. E05D 15/10

(52) U.S. Cl. CPC E05D 15/1042; E05Y 2201/638; E05Y 2201/688; E05Y 2900/148

(57) ABSTRACT

The present invention relates to a horizontal movement module for a horizontal movement window, and more particularly, to the horizontal movement module for the horizontal movement window that has a simple structure while improving productivity, operational performance, and sealing capability.

The present invention provides a horizontal movement module for a horizontal movement window comprising: a movement bar having a movement guide groove; a first plate on which the movement bar is seated; a second plate disposed to be opposite to the movement bar with respect to the first plate and configured to be moved relative to the first plate in coordination with a movement of the movement bar; and a roller module provided on the second plate, wherein the roller module includes a support roller configured to rotate about an oblique shaft having an inclination angle with respect to a virtual vertical axis and to contact a lateral counterpart to prevent a rotation of the second plate on a horizontal plane.

### CROSS-REFERENCE TO RELATED APPLICATIONS

A claim for priority under 35 U.S.C. § 119 is made to Korean Patent Application No. 10-2025-0045206 filed on Apr. 8, 2025, in the Korean Intellectual Property Office, the entire contents of which are hereby incorporated by reference.

### BACKGROUND OF THE INVENTION

### Field of the Invention

The present invention relates to a horizontal movement module for a horizontal movement window, and more particularly, to the horizontal movement module for the horizontal movement window which is simple in a structure and has improved productivity, operation performance and sealing performance.

### Description of the Related Art

Korean Patent Publication No. 10-2016-0033690 (hereinafter, referred to as “Patent Publication”) is a patent publication for an opening and closing system of a window or door. Especially, the Patent Publication relates to a device for pressing a sliding door wing against a fixed door frame.

A displacement device that allows a door wing (or door leaf) to be moved in parallel and normal directions to the door frame, is proposed in the Patent Publication. The door wing has at least one moving wheel, which includes a protrusion.

The fixed door frame is provided with a guide rail, and the door wing is provided with a guide member that moves along a direction of movement. This guide member has two grooves, one of which extends in the direction of movement and the other of which has a trajectory that interacts with the protrusion.

The guide member includes a roller, which is hinge-coupled to move at right angle to the direction of movement and is supported by a displaceable support portion. This configuration allows the door wing to be closed by being tightly pressed against the door frame when the door wing slides.

Particularly, there is a characteristic where clamping occurs between the door wing and the fixed door frame when the door wing moves in one direction. Multiple guide members may also be used.

The window or door opening and closing system disclosed in the Patent Publication focuses on enhancing a sealing force by pressing the door wing against the door frame while sliding. However, this type of horizontal movement module raises stability issues that may occur when applied to actual window systems.

Specifically, while a lower horizontal movement module moves horizontally or moves along a chassis, such a module may exhibit swaying or swing from side to side on a horizontal plane.

This indicates that while the guide member and the roller mechanism in Patent Publication may be effective for pressing the door wing in a perpendicular direction, they may be insufficient for providing stable support against various external forces or uneven load distribution occurring during horizontal movement.

If the lower movement module rotates from left to right (or from side to side) on the horizontal plane (i.e. a rotation or pivoting centered on Z-axis), this not only hinders smooth opening and closing operation of the window but can also cause poor sealing and insulation performance due to inadequate tight contact with the door frame. Furthermore, continuous rotation can accelerate wear of components, resulting in reduced durability.

Another issue relates to a curved shape of the groove for movement guide, which creates inconvenience of needing to distinguish left from right when the horizontal moving module is assembled. In Patent Publication, the groove in the guide member has a curved trajectory in a specific direction.

If left and right are incorrectly distinguished during assembly procedure, the system will not function properly, requiring time and effort to reassemble. This becomes a significant factor reducing productivity.

Moreover, in Patent Publication, since the curved movement guide groove is directly formed at a plate, it incurs high processing costs and time, and if the guide groove wears out, the entire plate must be replaced.

Since the movement guide groove in Patent Publication must be machined directly, it can pose a significant burden from a maintenance perspective. Particularly, as windows are products used for extended periods, a structure susceptible to wear leads to increased maintenance costs and a shortened product lifespan.

Additionally, in Patent Publication, an upper horizontal movement module and a lower horizontal movement module are installed at a top and a bottom of the window, respectively. In the case of the lower horizontal movement module, a groove of a movement roller is inserted into a center rail and thereby a position thereof is fixed. Therefore, the lower horizontal movement module does not sway from side to side relative to the entire rail (i.e., a space formed by the center rail and side walls of the center rail) along with the lower plate, the movement roller, and the horizontal roller.

In this case, the horizontal rollers must not make close contact with the side walls of the rail. If the horizontal rollers touch the side walls of the rail, friction occurs to prevent the horizontal rollers from rotating, and slipping which impedes window movement occurs.

Nevertheless, as described above, the lower horizontal movement module has the groove of the movement roller that is inserted into the center rail, for fixing its position. Therefore, the lower horizontal movement module does not sway left or right relative to the entire rail (i.e., the space formed by the center rail and the side walls of the center rail) along with the lower plate, the movement roller, and the horizontal roller.

However, in the case of the upper horizontal movement module, which has only horizontal roller without the movement roller, the horizontal roller thereof must also not make close contact with the side walls of the rail. The reason is that, as described above, if the horizontal rollers touch the side walls of the rail, the friction occurs to prevent the horizontal rollers from rotating, and the slipping occurs to hinder the window movement.

Since the horizontal rollers of the upper horizontal movement module are spaced apart from both side walls of the rail for these reasons, the problem clearly arises that an upper portion of the window may sway or swing from side to side (i.e., swaying phenomenon centered on X-axis direction—a direction of the window's slide movement) by an amount of such a spacing or clearance.

Therefore, while the technique described in Patent Publication may assist in a function of pressing the window, it presents technical issues in which it is difficult to ensure horizontal movement stability, assembly convenience is reduced, and manufacturing and maintenance costs may increase, when applied to an actual window system.

### SUMMARY OF THE INVENTION

The present invention is contemplated to solve problems in the prior art mentioned above. Thus, it is an object of the present invention to provide a horizontal movement module for a horizontal movement window that has a simple structure while improving productivity, operational performance, and sealing capability.

To achieve the above object, the present invention may provide a horizontal movement module for a horizontal movement window comprising: a movement bar having a movement guide groove; a first plate on which the movement bar is seated; a second plate disposed to be opposite to the movement bar with respect to the first plate and configured to be moved relative to the first plate in coordination with a movement of the movement bar; and a roller module provided on the second plate, wherein the roller module includes a support roller configured to rotate about an oblique shaft having an inclination angle with respect to a virtual vertical axis and to contact a lateral counterpart to prevent a rotation of the second plate on a horizontal plane.

The horizontal movement module may further comprise a roller module coupling portion provided at a lower portion of the second plate and allowing the roller module to be coupled thereto, and on a lower surface of the roller module coupling portion, the oblique shaft of the support roller may be connected.

The roller module may include a plurality of support rollers provided in a longitudinal direction and a lateral direction.

An outer surface of the support roller may be configured to be perpendicular to the horizontal plane in upward and downward directions, such that the counterpart and the outer surface of the support roller are continuously contacted with each other in the upward and downward directions.

The movement bar may be disposed in a longitudinal direction of the first plate, the first plate may be provided with a resting groove in which the movement bar is seated, and the resting groove may be provided with an opening. Further, the movement bar may include an interlock member that interlocks the movement guide groove of the movement bar with the second plate, and the second plate may be formed with an interlock member coupling hole to which the interlock member passing through the opening while being fitted into the movement guide groove provided in the movement bar, is coupled.

The movement guide groove may include: a first movement guide groove configured to be offset toward a first side with respect to a centerline in a longitudinal direction of the movement bar; a second movement guide groove configured to be offset toward a second side which is opposite to the first side; and a third movement guide groove configured to connect the first movement guide groove and the second movement guide groove.

The first movement guide groove and the second movement guide groove may be formed parallel to the centerline in the longitudinal direction of the movement bar, and the third movement guide groove may be arranged to cross the centerline in the longitudinal direction of the movement bar while forming a predetermined oblique angle with respect to the centerline.

The horizontal movement module may further comprise a movement inducing member connecting portion which is provided to the movement bar and allows a movement inducing member providing to the movement bar an external force for moving the movement bar, to be connected thereto.

Further, the present invention may provide a horizontal movement module for a horizontal movement window comprising: a movement bar having a movement guide groove; a first plate on which the movement bar is seated; a second plate disposed to be opposite to the movement bar with respect to the first plate and configured to be moved relative to the first plate in coordination with a movement of the movement bar; and a roller module provided on the second plate, wherein the roller module includes: a movement roller configured to rotate about a horizontal shaft and to guide a movement perpendicular to the horizontal shaft in a horizontal direction; and a support roller configured to rotate about an oblique shaft having an inclination angle with respect to a virtual vertical axis and to contact a lateral counterpart to prevent a rotation of the second plate on a horizontal plane.

The movement bar may be disposed in a longitudinal direction of the first plate, the first plate may be provided with a resting groove in which the movement bar is seated, and the resting groove may be provided with an opening. Further, the movement bar may include an interlock member that interlocks the movement guide groove of the movement bar with the second plate, and the second plate may be formed with an interlock member coupling hole to which the interlock member passing through the opening while being fitted into the movement guide groove provided in the movement bar, is coupled.

The movement guide groove may include: a first movement guide groove configured to be offset toward a first side with respect to a centerline in a longitudinal direction of the movement bar; a second movement guide groove configured to be offset toward a second side which is opposite to the first side; and a third movement guide groove configured to connect the first movement guide groove and the second movement guide groove.

The first movement guide groove and the second movement guide groove may be formed parallel to the centerline in the longitudinal direction of the movement bar, and the third movement guide groove may be arranged to cross the centerline in the longitudinal direction of the movement bar while forming a predetermined oblique angle with respect to the centerline.

The horizontal movement module may further comprise a movement inducing member connecting portion which is provided to the movement bar and allows a movement inducing member providing to the movement bar an external force for moving the movement bar, to be connected thereto.

The horizontal movement module may further comprise a roller module coupling portion provided at a lower portion of the second plate and allowing the roller module to be coupled thereto, and on a lower surface of the roller module coupling portion, the oblique shaft of the support roller may be connected.

The roller module may include a plurality of support rollers provided in a longitudinal direction and a lateral direction.

An outer surface of the support roller may be configured to be perpendicular to the horizontal plane in upward and downward directions, such that the counterpart and the outer surface of the support roller are continuously contacted with each other in the upward and downward directions.

The second plate may be inserted into a lower portion of the first plate, a guide groove may be provided to the lower portion of the first plate to guide a relative movement between the first plate and the second plate, and a guide step may be provided at the second plate to be inserted into the guide groove.

Details of examples or implementations will be described in the following with reference to the accompanying drawings. Other features will be apparent from the description and drawings, and from the claims.

### BRIEF DESCRIPTION OF THE DRAWINGS

The present invention will become more fully understood from the detailed description given below and the accompanying drawings, which are given by illustration only, and thus are not intended to limit the scope of the present invention, wherein:

FIG. 1 is a side view of a window in an open state;

FIG. 2 is a side view of the window in a closed state;

FIG. 3 is a front sectional view of the window in the open state;

FIG. 4 is a front sectional view of the window in the closed state;

FIG. 5 is a drawing showing a lower horizontal movement module installed on a window frame;

FIG. 6 is a partially enlarged view of FIG. 5;

FIG. 7 and FIG. 8 are exploded perspective views of the lower horizontal movement module;

FIG. 9 is a top view of a lower movement bar;

FIG. 10 is a front view of the lower horizontal movement module with movement rollers omitted;

FIG. 11 is a drawing showing an upper horizontal movement module installed on the window frame;

FIG. 12 is a partially enlarged view of FIG. 11;

FIG. 13 and FIG. 14 are exploded perspective views of the upper horizontal movement module;

FIG. 15 is a top view of an upper movement bar;

FIG. 16 is a front view of the upper horizontal movement module;

FIG. 17 is a lower perspective view of the lower movement module in the open state;

FIG. 18 is an upper perspective view of the lower movement module in the open state;

FIG. 19 is a lower perspective view of the lower movement module in the closed state;

FIG. 20 is an upper perspective view of the lower movement module in the closed state;

FIG. 21A is a bottom view of the lower movement module in the open state;

FIG. 21B is a bottom view of the lower movement module in the closed state;

FIG. 22A is a top view of the lower movement module in the open state;

FIG. 22B is a top view of the lower movement module in the closed state;

FIG. 23A is a front view of the lower movement module in the open state;

FIG. 23B is a front view of the lower movement module in the closed state;

FIG. 24A is a side view of the lower movement module in the open state;

FIG. 24B is a side view of the lower movement module in the closed state;

FIG. 25 is a lower perspective view of the upper movement module in the open state;

FIG. 26 is an upper perspective view of the upper movement module in the open state;

FIG. 27 is a lower perspective view of the upper movement module in the closed state;

FIG. 28 is an upper perspective view of the upper movement module in the closed state;

FIG. 29A is a bottom view of the upper movement module in the open state;

FIG. 29B is a bottom view of the upper movement module in the closed state;

FIG. 30A is a top view of the upper movement module in the open state;

FIG. 30B is a top view of the upper movement module in the closed state;

FIG. 31A is a front view of the upper movement module in the open state;

FIG. 31B is a front view of the upper movement module in the closed state; and

FIG. 32A is a side view of the upper movement module in the open state;

FIG. 32B is a side view of the upper movement module in the closed state.

### DETAILED DESCRIPTION OF THE PREFERRED EMBODIMENT

Description for the present invention will now be given in detail according to examples disclosed herein, with reference to the accompanying drawings.

For the sake of a brief description with reference to the drawings, the same or equivalent components may be provided with the same reference numbers, and description thereof will not be repeated. In the following, any conventional art which is well-known to one of ordinary skill in the relevant art has generally been omitted for the sake of brevity. The accompanying drawings are used to help easily understand various technical features and it should be understood that the examples presented herein are not limited by the accompanying drawings. As such, the present invention should be construed to extend to any alterations, equivalents, and substitutes in addition to those which are particularly set out in the accompanying drawings.

A singular representation may include a plural representation unless it represents a definitely different meaning from the context.

It will be understood that although the terms “first,” “second,” etc., may be used herein to describe various components, these components should not be limited by these terms. These terms are only used to distinguish one component from another component.

The term “and/or” includes any combination of a plurality of related listed items or any one of a plurality of related listed items.

It should be understood that when a component is referred to as being “connected to” or “coupled to” another component, this component may be directly connected to or coupled to another component, or any intervening components may be present between the components. In contrast, when a component is referred to as being “directly connected to” or “directly coupled to” another component, there are no intervening components present.

Terms such as “comprise”, “include” or “have” are used herein and should be understood that they are intended to indicate an existence of several components, functions or steps, disclosed in the specification, and it is also understood that greater or fewer components, functions, or steps may likewise be utilized. Moreover, due to the same reasons, it is also understood that the present invention includes any combinations of features, numerals, steps, operations, components, parts and the like partially omitted from the related or involved features, numerals, steps, operations, components, and parts described using the aforementioned terms unless deviating from the intentions of the original disclosure.

Hereinafter, embodiments will now be described in detail with reference to the accompanying drawings, wherein identical or corresponding components, regardless of reference numerals, are assigned the same reference numerals and redundant descriptions thereof are omitted.

A window system 10 having a horizontal movement function to which the present invention applies (hereinafter referred to as “window”) comprises a chassis 20 having a rail formed therein and an opening 21 within which the window can move, and a window 30 which is secured or seated inside the chassis 20 and is capable of sliding movement.

The window 30 is provided with a window frame 31 around its perimeter, and a rotatable or pivotable handle 40 is provided on one surface of the window frame 31. The handle 40 is capable of rotating 180 ° in an up and down directions. The state of the window according to a position of the handle 40 is as follows.

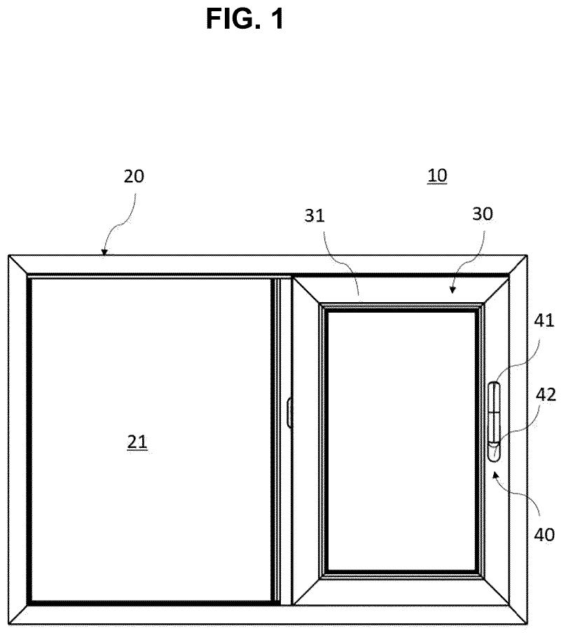

As shown in FIG. 1, when an end portion 41 of the handle 40 (opposite to a pivot portion 42) is facing upward, the window 30 is in an openable state. There is no horizontal tight contact between the window frame 31 and the chassis 20, and the window frame 31 is not interfering with the chassis 20 at any points.

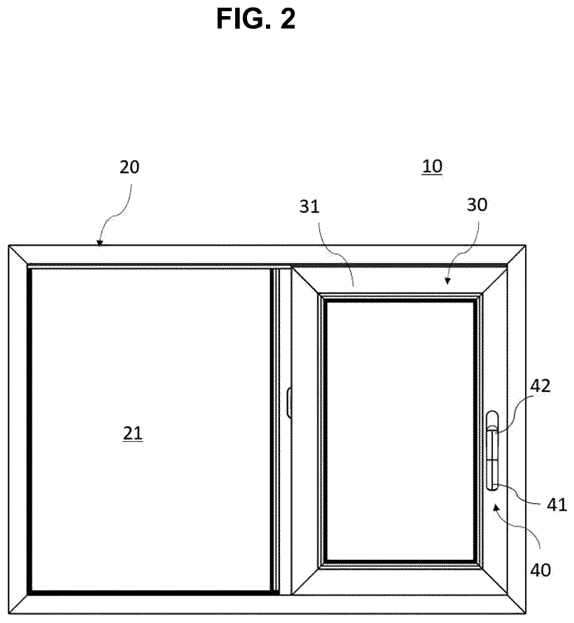

In contrast, as shown in FIG. 2, when the end portion 41 of the handle 40 (opposite to the pivot portion 42) is facing downward, the window 30 is in a sealed state. The window frame 31 is moved horizontally with respect to the chassis 20 compared to the open state, such that the window frame 31 is in tight contact with the chassis 20.

In this case, since a latch portion (not shown) of the window 30, which will be described later, is in a state of being hooked or caught on a striker (not shown) of the chassis 20, the window 30 may not slide and thus may not be opened.

Meanwhile, when the end portion 41 of the handle 40 (opposite to the pivot portion 42) is in a horizontal state, the horizontal tight contact between the window frame 31 and the chassis 20 is released and they are spaced apart from each other, but since the latch portion (not shown) of the window 30 is in a state of being hooked or caught on the striker (not shown) of the chassis 20, the window 30 may not be opened, but air may flow into a spaced gap between the window frame 31 and the chassis 20, and may be ventilated. This allows the air to move in and out of the gap and perform a ventilation function.

That is, when the window frame 31 is attempted to be moved in an opening direction, the window frame 31 tries to move while rattling, but as a result, the window frame 41 may not be opened due to the latching relationship between the latch portion (not shown) and the striker (not shown) described above.

A horizontal movement module according to the present invention includes an upper horizontal movement module 2000 disposed on an upper portion (or a top portion) of the window frame 31 and a lower horizontal movement module 1000 disposed on a lower portion (or a bottom portion) of the window frame 31.

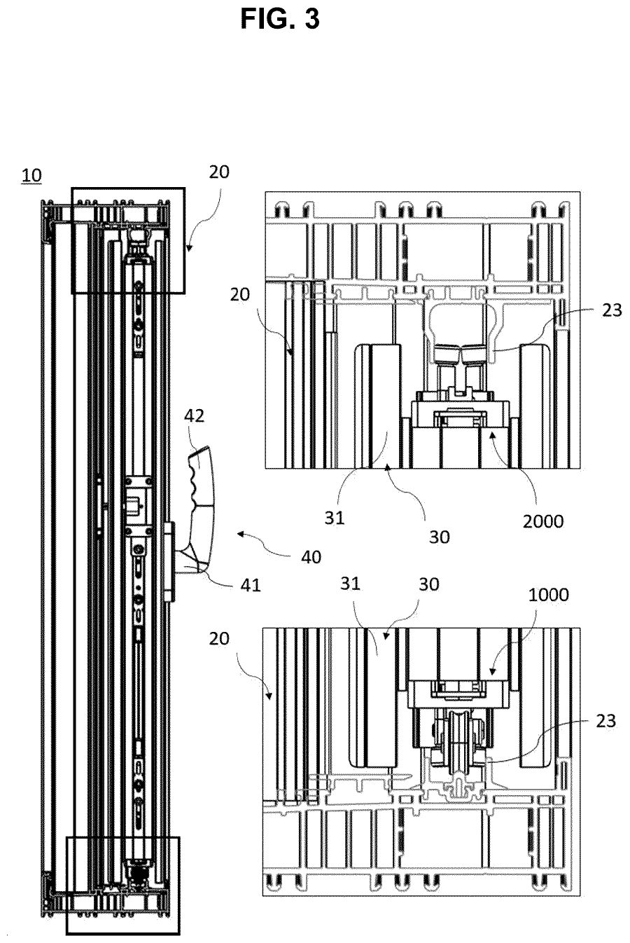

As shown in FIG. 3, in the openable state of the window 30, the upper horizontal movement module 2000 and the lower horizontal movement module 1000 are in a state of performing no horizontal movement action, and the window frame 31 remains spaced apart from the chassis 20.

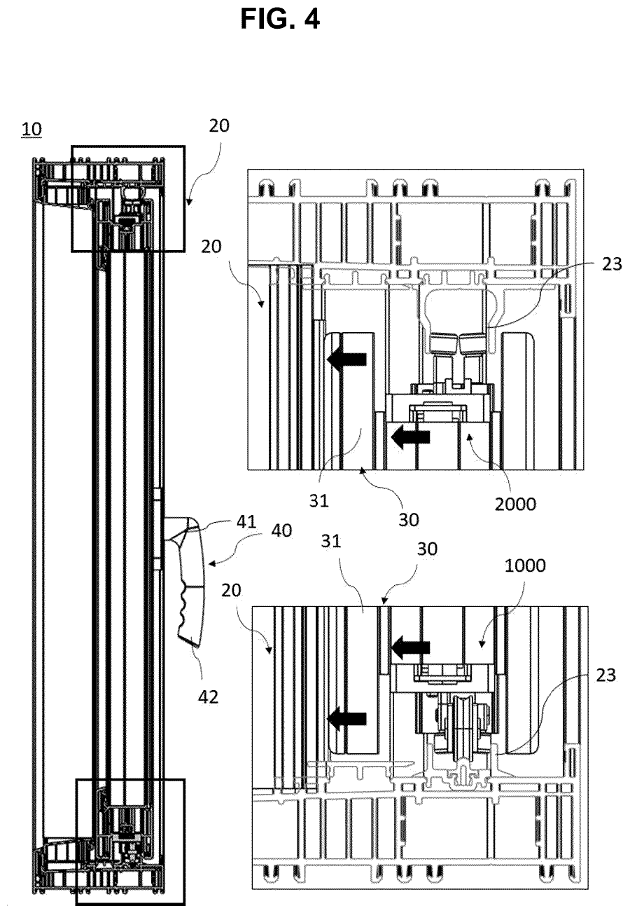

In contrast, as shown in FIG. 4, in the closed state of the window 30, the upper horizontal movement module 2000 and the lower horizontal movement module 1000 are in a state in which the upper horizontal movement module 2000 and the lower horizontal movement module 1000 have made the horizontal movement action, and the window frame 31 is moved to one side in accordance with the horizontal movement action of the upper horizontal movement module 2000 and the lower horizontal movement module 1000, and thus is in tight contact with the chassis 20.

The specific structure and the horizontal movement action of the lower horizontal movement module 1000 and the upper horizontal movement module 2000 will be described later.

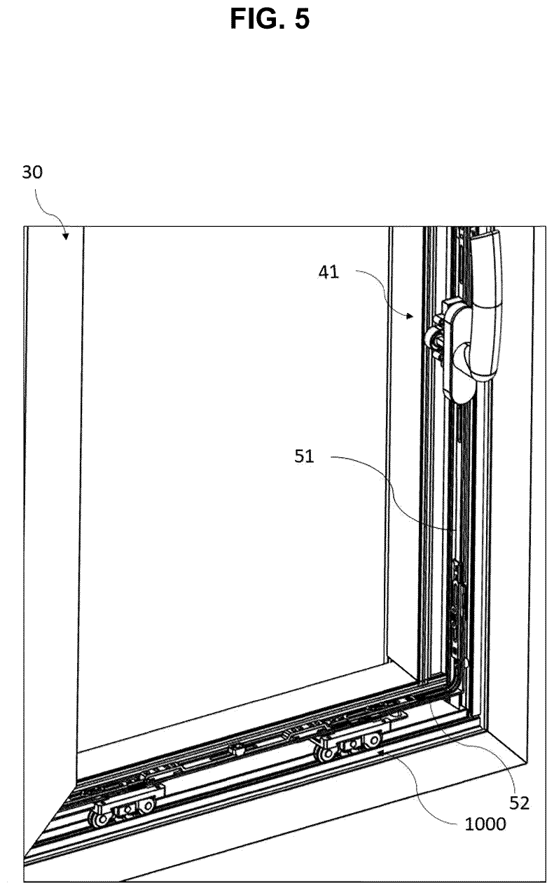

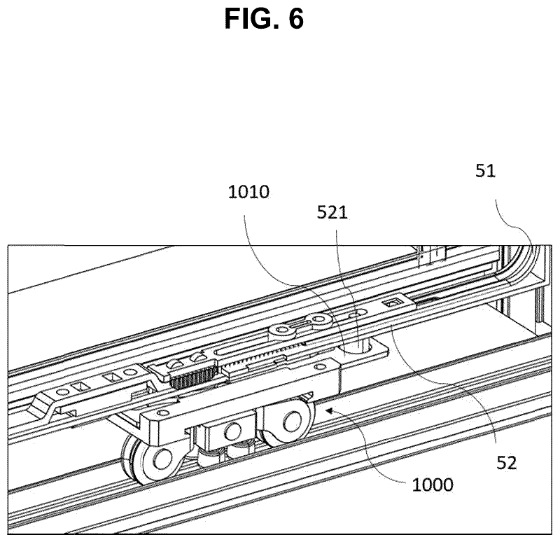

As shown in FIGS. 5 and 6, the lower horizontal movement module 1000 is installed on a lower or bottom surface of the window frame 31.

In FIGS. 5 and 6, an outer body portion forming the window frame 31 is omitted, and an internal structure of the window frame 31 and the lower horizontal movement module 1000 connected thereto are shown.

The handle 40 is interlocked, linked or engaged with a first actuation bar 51 via a predetermined connection mechanism. The first actuation bar 51 is a bar in the form of an elongated band which is provided on a side portion of the window frame 31 and is capable of moving upwardly or downwardly in accordance with the rotation of the handle 40.

A second actuating bar 52 is provided in the lower portion of the window frame 31. Such a second actuating bar 52 is connected to the first actuating bar 51 and is configured to move in accordance with the movement of the first actuating bar 51 in response to the movement of the handle 40.

Further, the second actuation bar 52 is connected to a lower movement bar 1010, which is provided in the lower horizontal movement module 1000. As will be described later, a horizontal movement of the lower horizontal movement module 1000 may be accomplished in accordance with the movement of the lower movement bar 1010.

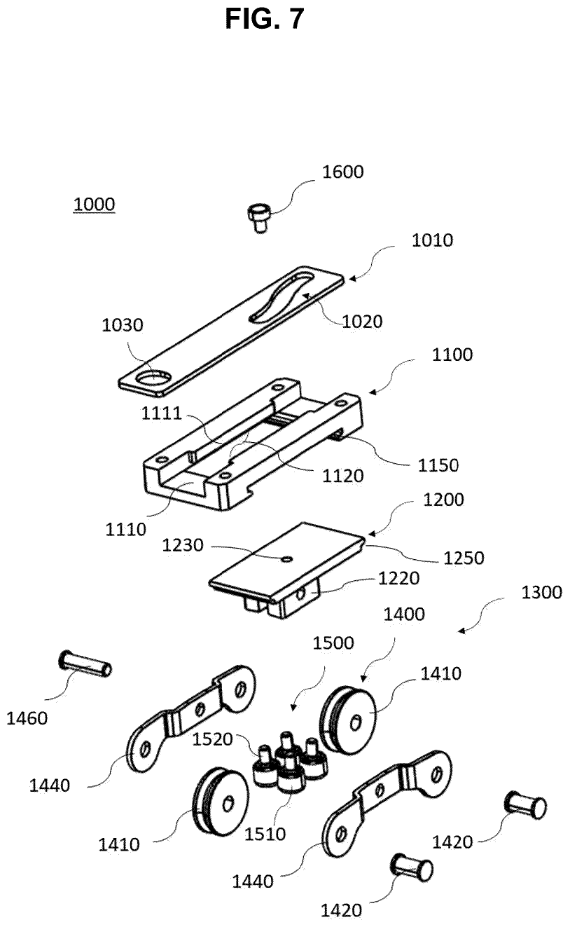

As shown in FIGS. 7-10, the lower horizontal movement module 1000 includes a lower movement bar 1010 having a movement guide groove 1020, a lower first plate 1100 on which the lower movement bar 1010 is rested or seated and which is coupled to the lower or bottom surface of the window frame 31, a lower second plate 1200 disposed opposite to the lower movement bar 1010 with respect to the lower first plate 1100 and configured to be moved relative to the lower first plate 1100 in coordination or conjunction with the movement of the lower movement bar 1010, and a lower roller module 1300 provided on the lower second plate 1200.

The lower roller module 1300 includes a lower movement roller 1410 rotatably arranged about a horizontal shaft 1420 to guide a movement perpendicular or normal to the horizontal shaft 1420 in a horizontal direction, and a lower support roller 1510 configured to rotate about a lower oblique shaft 1520 formed along a lower oblique line CL1-CL1′ or CL2-CL2′ having an inclination angle with respect to an imaginary or virtual vertical axis VL-VL′ and to contact an object (or a counterpart) located on the side (i.e. each inner surface of both side walls of a lower rail) to prevent a rotation of the lower second plate 1200 on the horizontal plane.

Two lower movement rollers 1410 may be provided in forward and backward directions, and may be rotatably coupled to a lower movement roller support plate 1440 by the horizontal axis 1420. A center of the lower movement roller support plate 1440 is coupled to a sidewall of a lower roller module coupling portion 1220 by a support shaft 1460.

The lower movement bar 1010 is disposed in a longitudinal direction of the lower first plate 1100, the lower first plate 1100 is provided with a lower resting groove 1110 in which the lower movement bar 1010 is rested or seated, and the lower resting groove 1110 is provided with a lower opening 1120.

The lower movement bar 1010 includes an interlock member 1600 that interlocks, links, or engages the movement guide groove 1020 with the lower second plate 1200, and the lower second plate 1200 is formed with an interlock member coupling hole 1230 to which the interlock member 1600 passing through the lower opening 1120 with being fitted into the movement guide groove 1020 provided in the lower movement bar 1010, is coupled.

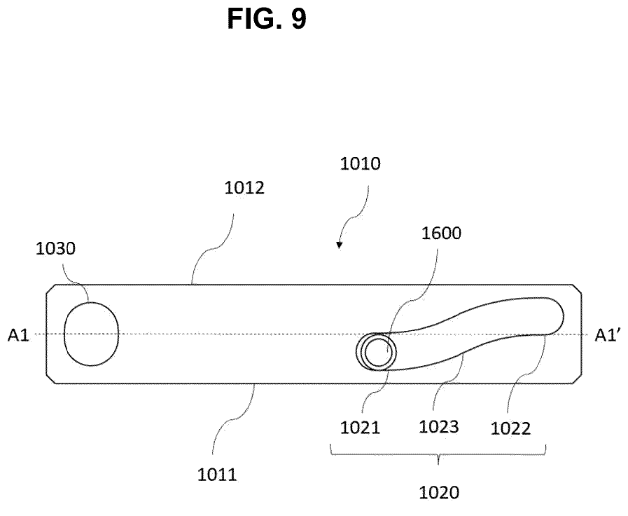

As shown in FIG. 9, the movement guide groove 1020 includes a first movement guide groove 1021 offset, skewed, or deflected (i.e., tilted) toward a first side 1011 with respect to a centerline A1-A1′ in the longitudinal direction of the lower movement bar 1010, a second movement guide groove 1022 offset toward a second side 1012 opposite to the first side 1011, and a third movement guide groove 1023 connecting the first movement guide groove 1021 and the second movement guide groove 1022.

The first movement guide groove 1021 and the second movement guide groove 1022 are formed parallel to the longitudinal center line A-A′ of the lower movement bar 1010, and an imaginary or virtual center line of the third movement guide groove 1023 is arranged to intersect or cross while forming a predetermined oblique angle with respect to the longitudinal center line A1-A1′ of the lower movement bar 1010.

The lower movement bar 1010 is Connected to a movement inducing member 521 (see FIG. 6), which provides the force of the second actuating bar 52 to the lower movement bar 1010 to move the lower movement bar 1010.

For this purpose, the lower movement bar 1010 is provided with a movement inducing member connecting portion 1030. The movement inducing member 521 which is coupled to the movement inducing member connecting portion 1030 is preferably implemented in the form of a boss, a projection, a pin, or a screw, and the movement inducing member connecting portion 1030 is preferably provided in the form of a hole.

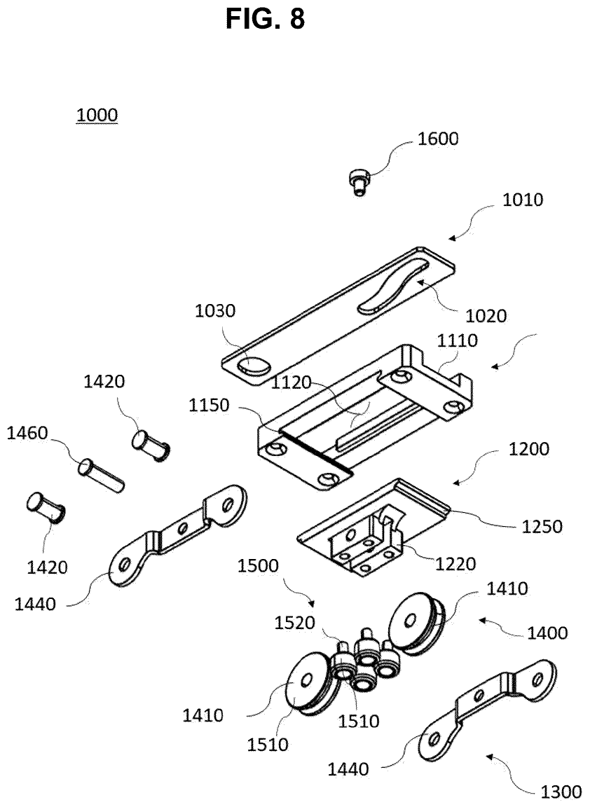

As shown in FIGS. 7 and 8, the lower roller module coupling portion 1220 in the form of a block to which the lower roller module 1300 is coupled, is provided at a lower portion of the lower second plate 1200.

On a lower or bottom surface of the lower roller module coupling portion 1220, the lower oblique shaft 1520 of the lower support roller 1510 is connected, and a plurality of lower support rollers 1510 may be provided in the longitudinal and lateral directions. In the present embodiment, two lower support rollers 1510 are shown in the longitudinal direction and two lower support rollers 1510 are shown in the lateral direction, but the quantities thereof are not limited to such numbers.

Since the plurality of lower support rollers 1510 are thus provided in the longitudinal direction and are in tight contact with and supported by the sidewalls of the rails 23 (see FIG. 3) at a plurality of points, it is possible to prevent the lower horizontal movement module 1000 from rotating from side to side on the horizontal plane when the lower horizontal movement module 1000 is in the horizontal movement action, or when the lower horizontal movement module 1000 moves along the chassis 20.

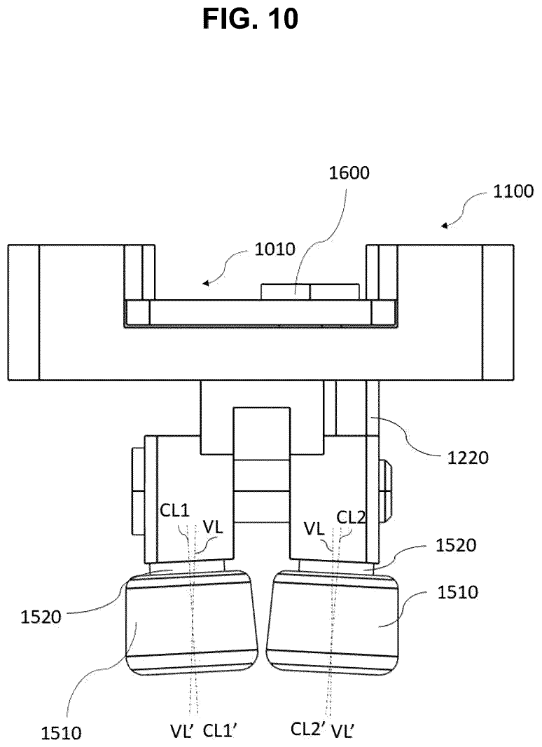

Further, as shown in FIG. 10, an outer surface of the lower support roller 1510 is configured to be perpendicular or normal to the horizontal plane in the upward and downward directions, so that the rail sidewall 23 (see FIG. 3) of the chassis 20 and the outer surface of the lower support roller 1510 may be continuously contacted in the upward and downward directions, thereby realizing a line contact and thus further increasing contact support stability when compared to a point contact.

Meanwhile, as shown in FIGS. 7 and 8, the lower second plate 1200 is inserted into a lower portion of the lower first plate 1100. A guide groove 1150 is provided to the lower portion of the lower first plate 1100 to guide a relative movement between the lower first plate 1100 and the lower second plate 1200, and a guide step 1250 is provided at the lower second plate 1200 to be inserted in the guide groove 1150.

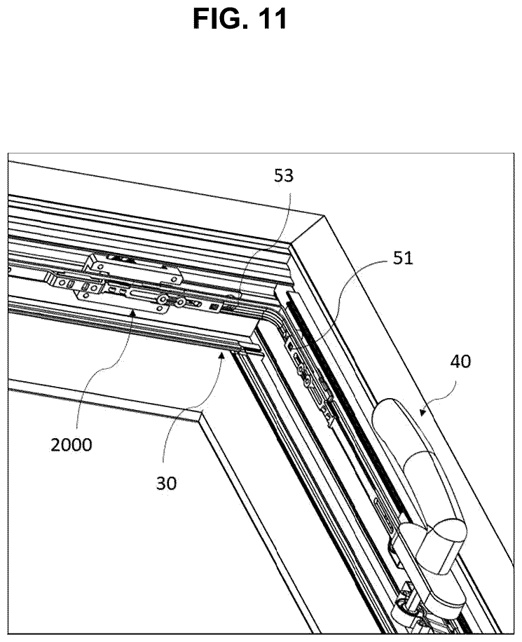

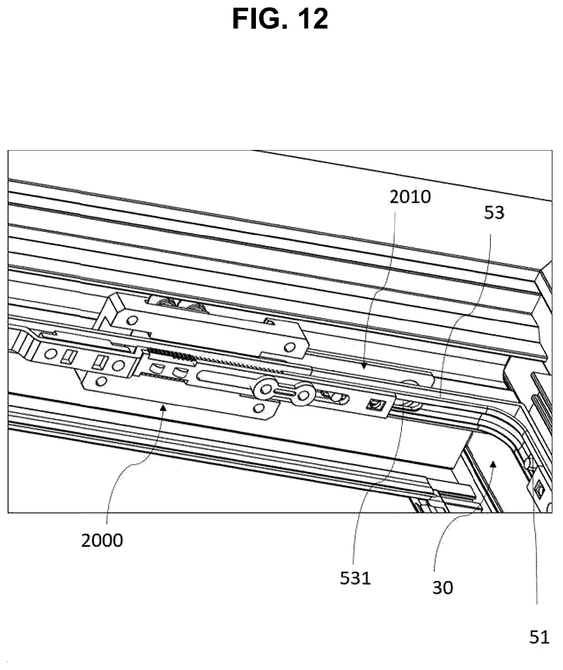

As shown in FIGS. 11 and 12, the upper horizontal movement module 2000 is installed on an upper surface (or a top surface) of the window frame 31.

In FIGS. 11 and 12, the outer body portion comprising the window frame 31 is omitted, and the internal structure of the window frame 31 and the upper horizontal movement module 2000 connected thereto are shown.

As described above, the handle 40 is interlocked, engaged, or linked with the first actuation bar 51 via the predetermined connection mechanism.

A third actuation bar 53 is provided in the upper portion of the window frame 31, such a third actuation bar 53 is connected with the first actuation bar 51 and is configured to move in accordance with the movement of the first actuation bar 51 in response to the movement of the handle 40.

Further, the third actuation bar 53 is connected to an upper movement bar 2010 which is provided in the upper horizontal movement module 2000. As will be described later, a horizontal movement of the upper horizontal movement module 2000 may be accomplished in accordance with the operation of the upper movement bar 2010.

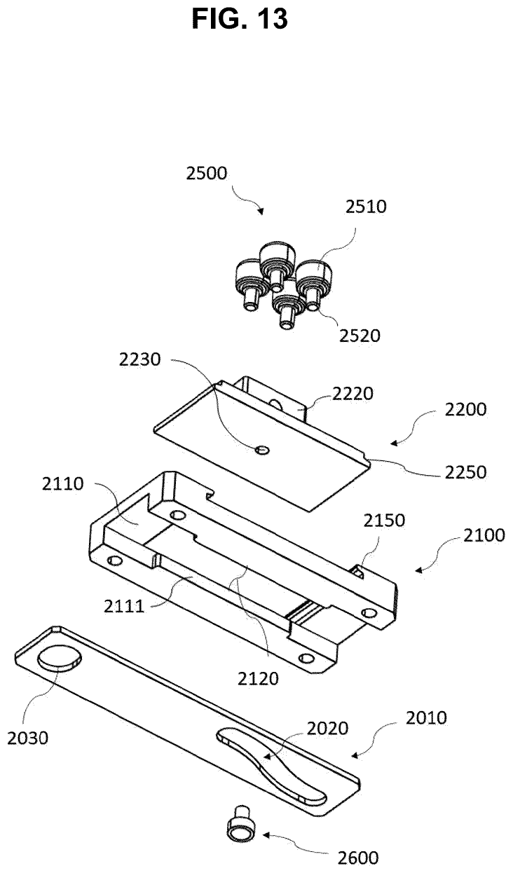

As shown in FIGS. 13-16, the upper horizontal movement module 2000 includes an upper movement bar 2010 having a movement guide groove 2020, an upper first plate 2100 on which the upper movement bar 2010 is rested or seated and which is coupled to the upper or top surface of the window frame 31, an upper second plate 2200 disposed opposite to the upper movement bar 2010 with respect to the upper first plate 2100 and configured to be moved relative to the upper first plate 2100 in coordination or conjunction with the movement of the upper movement bar 2010, and an upper roller module 2500 provided on the upper second plate 2200.

The upper roller module 2500 includes an upper support roller 2510 configured to rotate about an upper oblique shaft 2520 formed along an upper oblique line CL3-CL3′ or CL4-CL4′ having an inclination angle with respect to an imaginary or virtual vertical axis VL-VL′, and to contact an object (or a counterpart) located on the side (e.g., each inner surface of both sidewalls of an upper rail) to prevent a rotation of the upper second plate 2200 on the horizontal plane.

The upper movement bar 2010 is disposed in a longitudinal direction of the upper first plate 2100, the upper first plate 2100 is provided with an upper resting groove 2110 in which the upper movement bar 2010 is seated or rested, and the upper resting groove 1110 is provided with an upper opening 2120.

The upper movement bar 2010 includes an interlock member 2600 that interlocks, links, or engages the movement guide groove 2020 with the upper second plate 2200, and the upper second plate 2200 is formed with an interlock member coupling hole 2230 to which the interlocking member 2600 passing through the upper opening 2120 with being fitted into the movement guide groove 2020 provided in the upper movement bar 2010, is coupled.

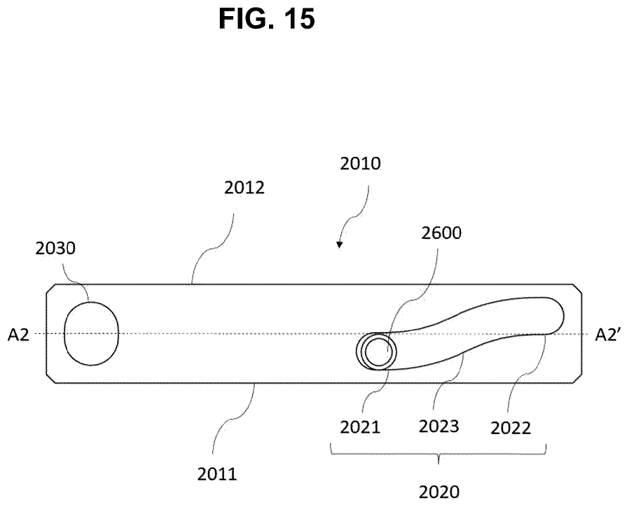

As shown in FIG. 15, the movement guide groove 2020 includes a first movement guide groove 2021 offset, skewed, or deflected (i.e., tilted) toward a first side 2011 with respect to a centerline A2-A2′ in the longitudinal direction of the upper movement bar 2010, a second movement guide groove 2022 offset toward a second side 2012 opposite to the first side 2011, and a third movement guide groove 2023 connecting the first movement guide groove 2021 and the second movement guide groove 2022.

The first movement guide groove 2021 and the second movement guide groove 2022 are formed parallel to the longitudinal center line A2-A2′ of the upper movement bar 2010, and an imaginary or virtual center line of the third movement guide groove 2023 is arranged to intersect or cross by forming a predetermined oblique angle with respect to the longitudinal center line A2-A2′ of the upper movement bar 2010.

The third movement guide groove 2023 may be formed in a straight line in an oblique direction or in a curved line in an oblique direction.

Connected to the upper movement bar 2010 is a movement inducing member 531 which is provided to the third actuation bar 53 which moves the upper movement bar 2010 and provides the force of the third actuation bar 53 to the upper movement bar 2010.

To be connected to the movement inducing member 531 (see FIG. 12), the upper movement bar 2010 is provided with a movement inducing member connecting portion 2030. The movement inducing member 531 may be implemented in the form of a boss, a projection, a pin, or a screw, and the movement inducing member connecting portion 2030 is preferably provided in the form of a hole.

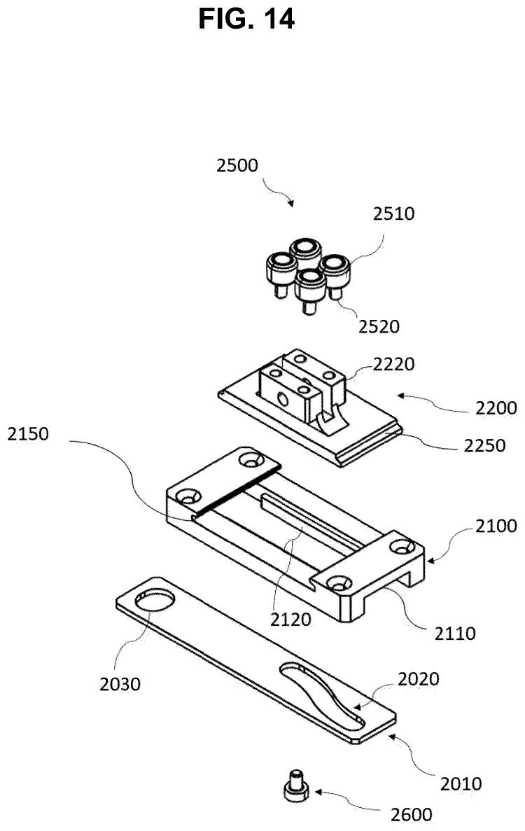

As shown in FIGS. 13 and 14, an upper roller module coupling portion 2220 in the form of a block to which the upper roller module 2500 is coupled, is provided at an upper portion of the upper second plate 2200.

On an upper surface (or a top surface) of the lower roller module coupling portion 2220, the upper oblique shaft 2520 of the upper support roller 2510 is connected, and a plurality of lower support rollers 1510 are provided in the longitudinal and lateral (or lengthwise and widthwise) directions.

In the present embodiment, as shown in the related drawings, two upper support rollers 2510 are arranged in the longitudinal direction and two upper support rollers 2510 are arranged in the lateral direction, but the quantities thereof are not limited to such numbers.

As such, since the plurality of upper support rollers 2510 are provided in the longitudinal direction and are in tight contact with and supported by the sidewalls of the rails 23 at a plurality of points, it is possible to prevent the upper horizontal movement module 2000 from rotating from side to side on the horizontal plane when the upper horizontal movement module 2000 is in a horizontal movement action, or when the upper horizontal movement module 2000 moves along the chassis 20.

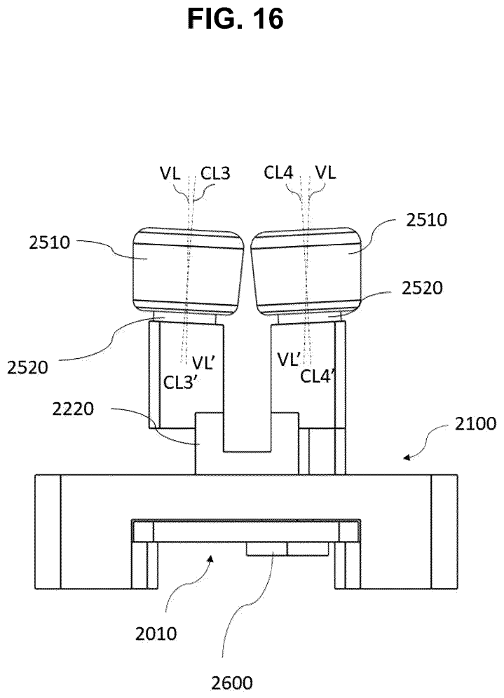

Further, as shown in FIG. 16, an outer surface of the upper support roller 2510 is configured to be perpendicular to the horizontal plane in the upward and downward directions, so that the rail sidewall 23 (see FIG. 3) of the chassis 20 and the outer surface of the upper support roller 2510 may be continuously contacted in the upward and downward directions.

With such a configuration, instead of a point contact, a line contact is realized and thus the contact support stability is further increased.

Meanwhile, as shown in FIGS. 13 and 14, the upper second plate 2200 is inserted into an upper portion of the upper first plate 2100, a guide groove 2150 is provided to the upper portion of the upper first plate 2100 to guide a relative movement between the upper first plate 2100 and the upper second plate 2200, and a guide step 2250 is provided at the upper second plate 2200 to be inserted into the guide groove 2150.

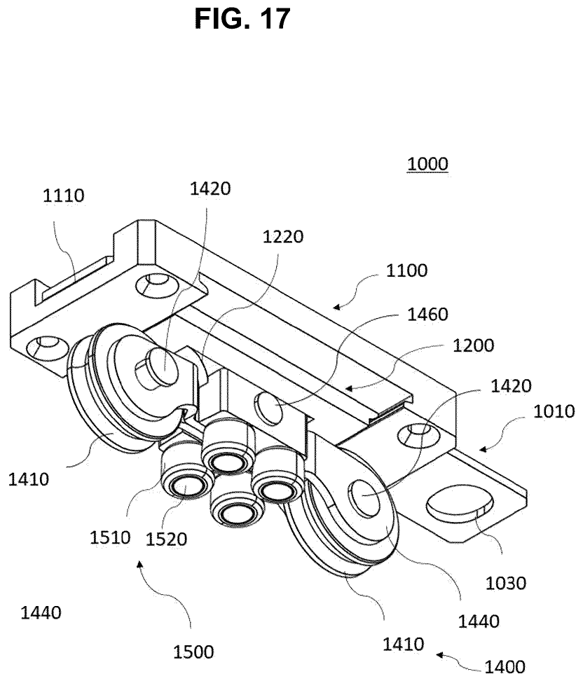

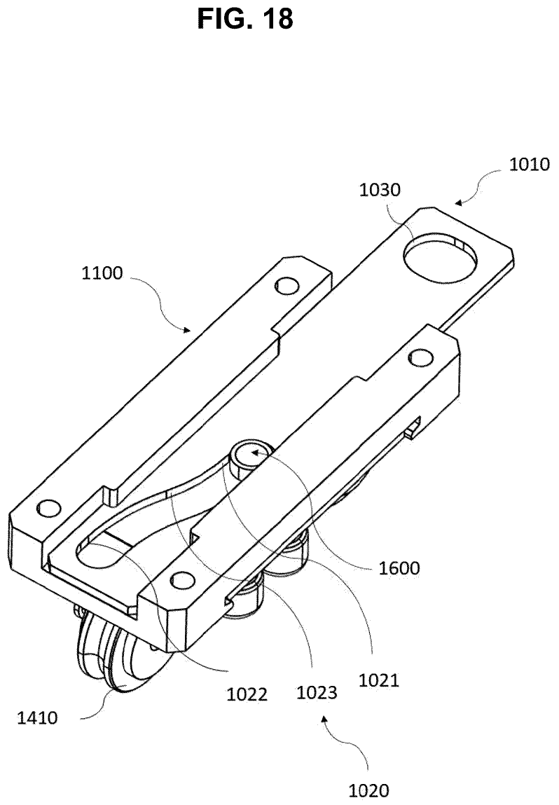

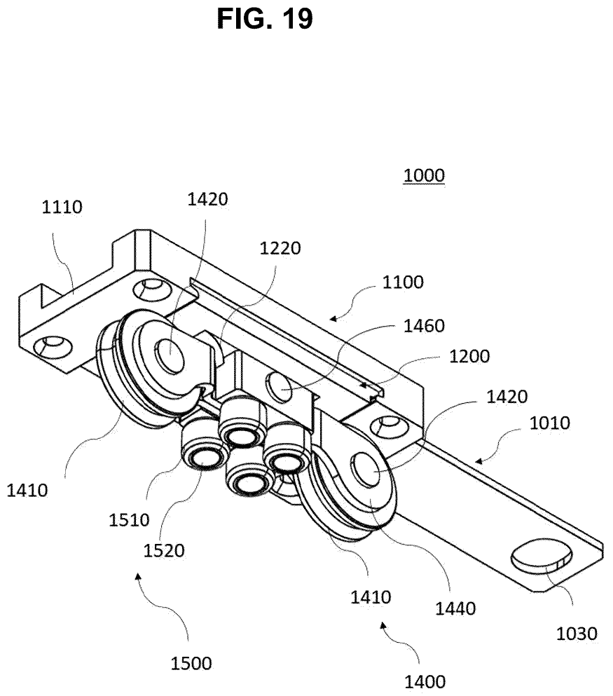

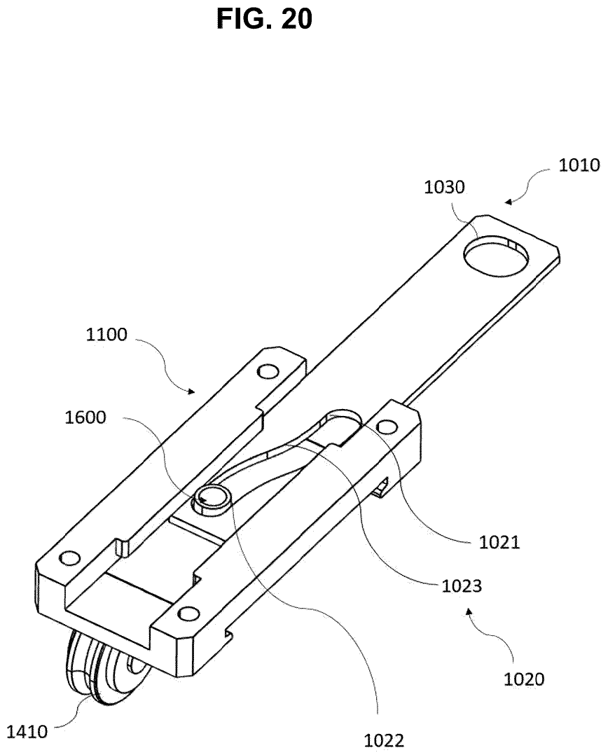

FIGS. 17 and 18 are a lower perspective view and an upper perspective view which show the arrangement state of the lower movement module 1000 in the open state of the window 30, respectively, and FIGS. 19 and 20 are a lower perspective view and an upper perspective view which show the arrangement state of the lower movement module 1000 in the closed state of the window 30, respectively.

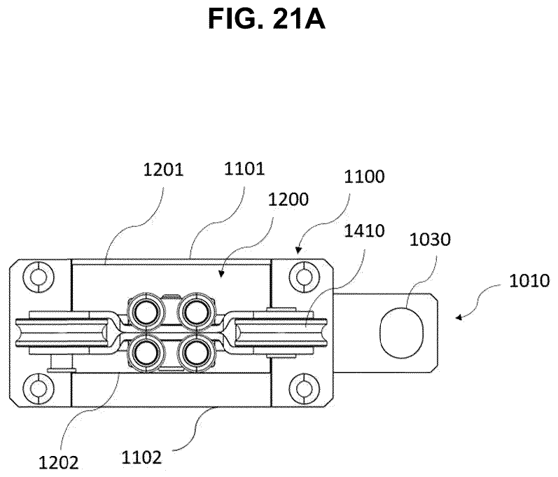

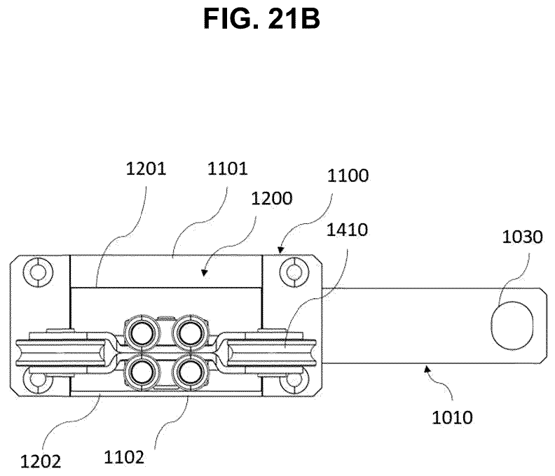

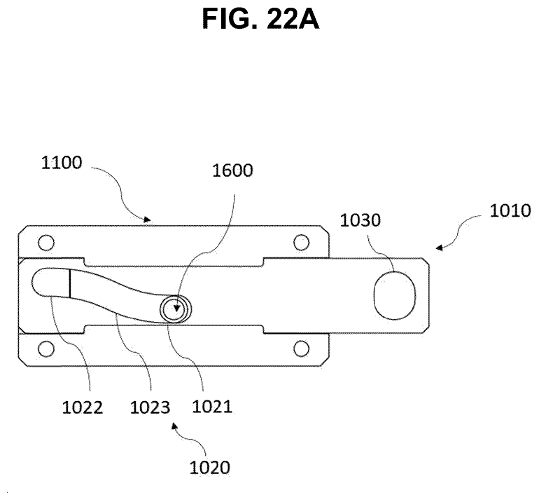

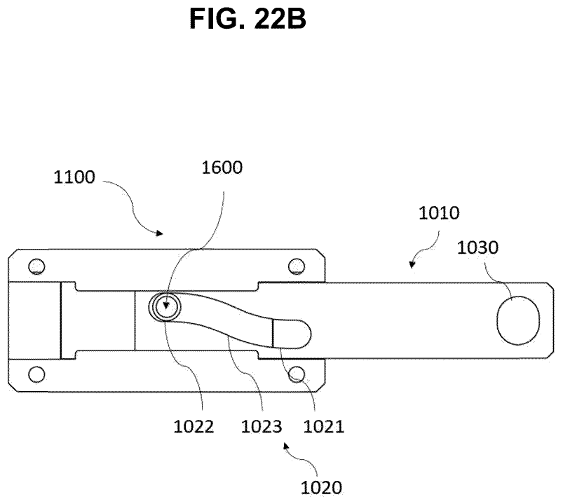

FIG. 21A is a bottom view of the lower movement module 1000 in the open state of the window 30, FIG. 21B is a bottom view of the lower movement module 1000 in the closed state of the window 30, FIG. 22A is a top view of the lower movement module 1000 in the open state of the window 30, and FIG. 22B is a top view of the lower movement module 1000 in the closed state of the window 30.

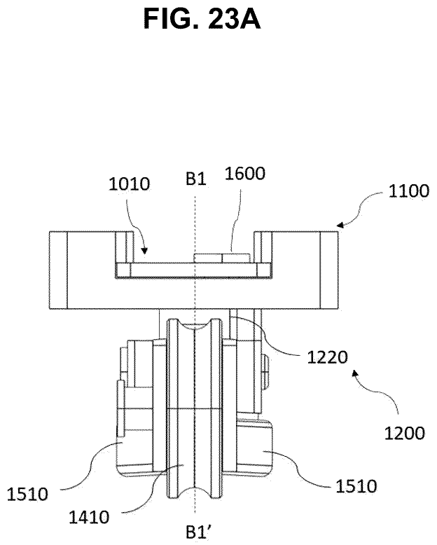

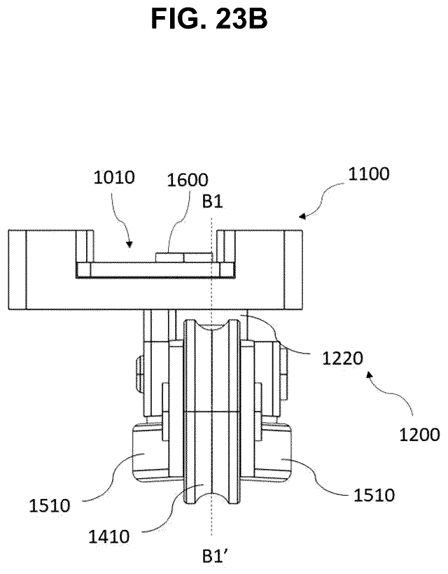

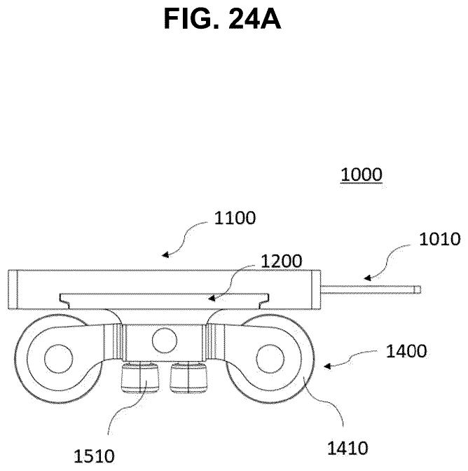

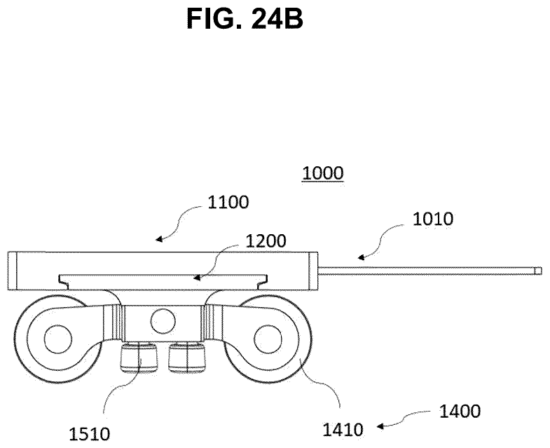

FIG. 23A is a front view of the lower movement module 1000 in the open state of the window 30, FIG. 23B is a front view of the lower movement module 1000 in the closed state of the window 30, FIG. 24A is a side view of the lower movement module 1000 in the open state of the window 30, and FIG. 24B is a side view of the lower movement module 1000 in the closed state of the window 30.

As shown in FIGS. 17 and 18 and FIGS. 21A, 22A, 23A, and 24A, in the open state of the window 30, the lower movement bar 1010 is moved by the second actuation bar 52 such that a rear end portion of the lower movement bar 1010 is aligned with a rear edge of the lower first plate 1100, and the lower movement bar 1010 is maximally accommodated within the lower first plate 1100.

Further, only a portion of a front end portion of the lower movement bar 1010 is arranged beyond a front end portion of the lower first plate 1100.

Meanwhile, the interlock member 1600 is arranged in the first movement guide groove 1021 located below.

In this state, the lower movement roller 1410 is disposed on a longitudinal centerline B1-B1′ of the lower horizontal movement module 1000, which overlaps with the longitudinal centerline A1-A1′ of the lower movement bar 1010.

A first long side 1201 of the lower second plate 1200 is disposed close to a first long side 1101 of the lower first plate 1100. And, a second long side 1202 of the lower second plate 1200 is spaced apart from a second long side 1102 of the lower first plate 1100.

In this state, when the lower movement bar 1010 is pulled by the second actuation bar 52, a relative horizontal movement between the lower first plate 1100 and the lower second plate 1200 occurs and the window 30 is converted to the closed state.

As illustrated in FIGS. 19 and 20 and FIGS. 21B, 22B, 23B, and 24B, in the closed state of the window 30, the lower movement bar 1010 is moved by the second actuation bar 52 such that the rear end portion of the lower movement bar 1010 enters inside the lower first plate 1100, and the lower movement bar 1010 is minimally accommodated inside the lower first plate 1100.

Further, the front end portion and the middle portion of the lower movement bar 1010 are arranged beyond the front end portion of the lower first plate 1100 by being maximally pulled by the second actuation bar 52.

Meanwhile, the interlock member 1600 is arranged in the second movement guide groove 1022 of the lower movement bar 1010.

In this state, the lower movement roller 1410 is deviated, offset or departed from the longitudinal center line B1-B1′ of the lower horizontal movement module 1000 and is arranged spaced apart from the longitudinal center line B1-B1′ to be next to the longitudinal center line B1-B1′ of the lower horizontal movement module 1000.

Due to the relative movement between the lower first plate 1100 and the lower second plate 1200, the second long side 1202 of the lower second plate 1200 and the second long side 1102 of the lower first plate 1100 are translated to be disposed close to each other, and the first long side 1201 of the lower second plate 1200 is spaced apart from the first long side 1101 of the lower first plate 1100.

In such a relative movement between the lower first plate 1100 and the lower second plate 1200, since the window frame 31 coupled to the lower first plate 1100 moves along with the lower first plate 1100, this ultimately causes a relative movement between the window frame 31 and the lower second plate 1200, which may cause an opening or closing action of the window 30.

Meanwhile, because a lower end portion of the lower support roller 1510 is disposed higher than a lower end portion of the lower movement roller 1410, the lower support roller 1510 does not contact a counterpart (i.e., a bottom surface of the rail) that contacts the lower movement roller 1410 and thus does not impede the movement.

The operation of the lower horizontal movement module 1000 has been described above, and the operation of the upper horizontal movement module 2000 will be described below.

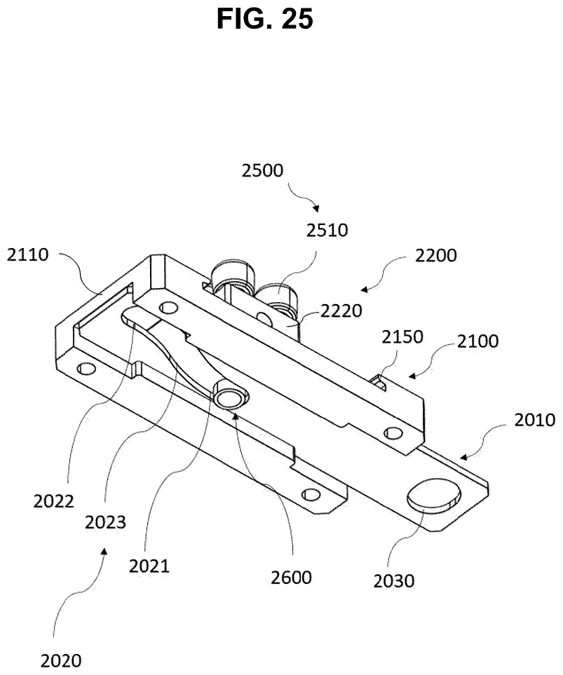

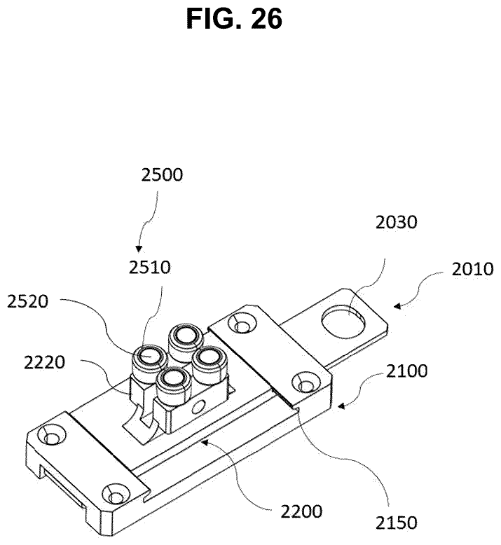

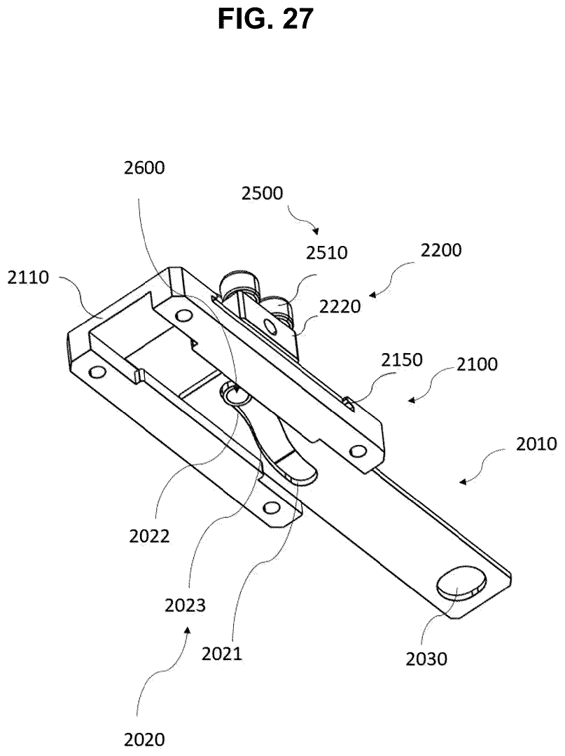

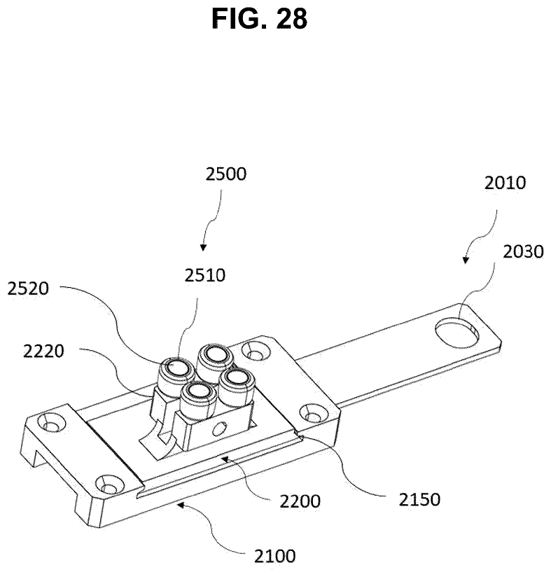

FIGS. 25 and 26 are a lower perspective view and an upper perspective view which show the arrangement state of the upper movement module 2000 in the open state of the window 30, respectively, and FIGS. 27 and 28 are a lower perspective view and an upper perspective view which show the arrangement state of the upper movement module 2000 in the closed state of the window 30, respectively.

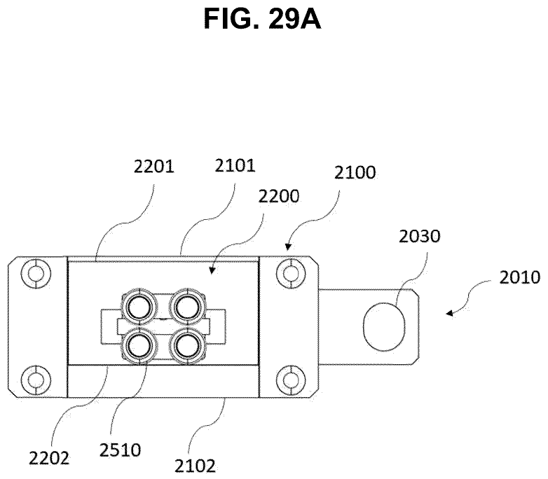

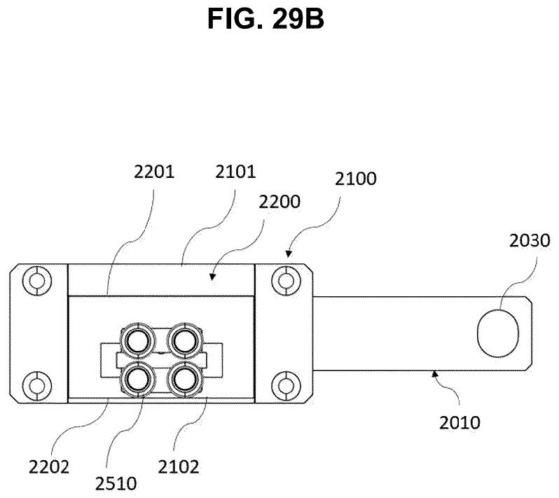

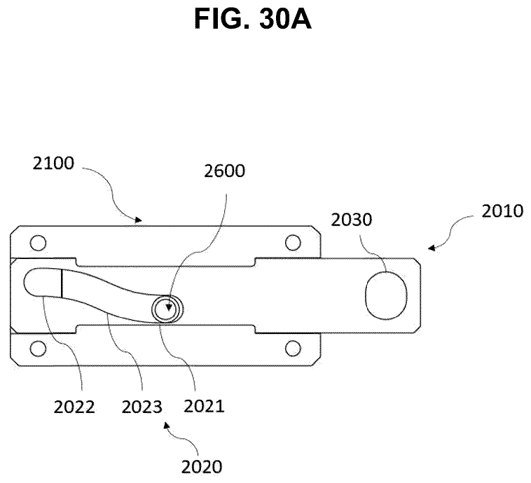

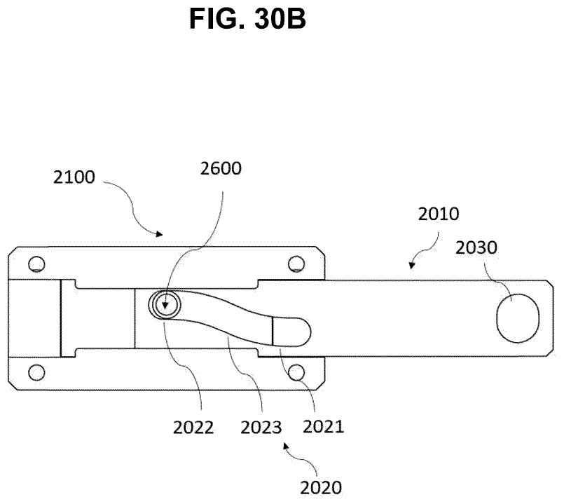

FIG. 29A is a bottom view of the upper movement module 2000 in the open state of the window 30, FIG. 29B is a bottom view of the upper movement module 2000 in the closed state of the window 30, FIG. 30A is a top view of the upper movement module 2000 in the open state of the window 30, and FIG. 30B is a top view of the upper movement module 2000 in the closed state of the window 30.

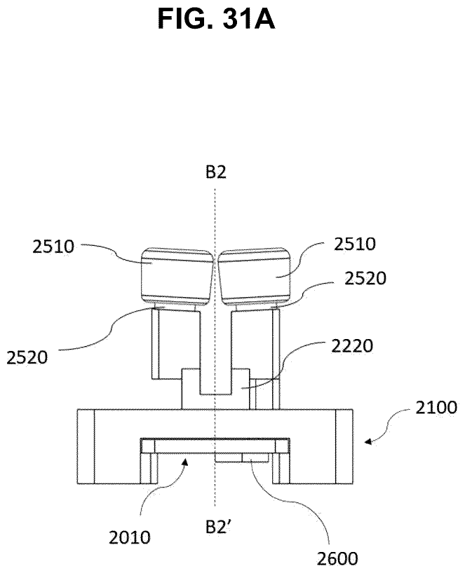

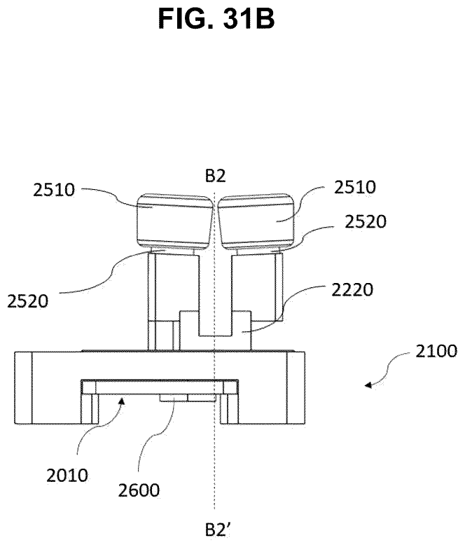

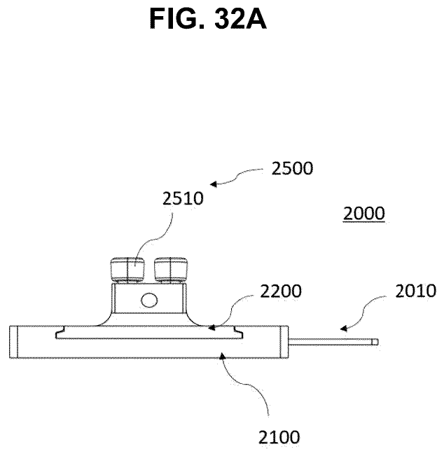

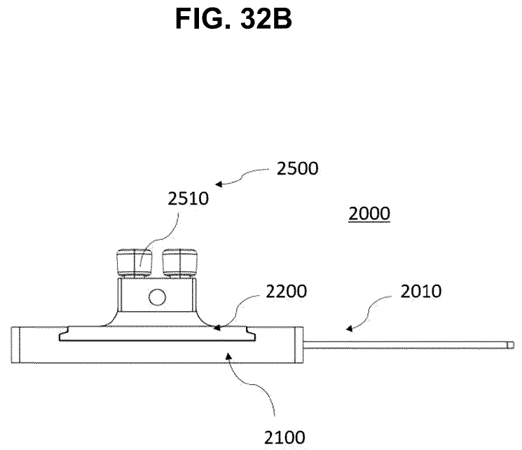

FIG. 31A is a front view of the upper movement module 2000 in the open state of the window 30, FIG. 31B is a front view of the upper movement module 2000 in the closed state of the window 30, FIG. 32A is a side view of the upper movement module 2000 in the open state of the window 30, and FIG. 32B is a side view of the upper movement module 2000 in the closed state of the window 30.

As shown in FIGS. 25 and 26 and FIGS. 29A, 30A, 31A, and 32A, in the open state of the window 30, the upper movement bar 2010 is moved by the third actuation bar 52 such that a rear end portion of the upper movement bar 2010 is aligned with a rear edge of the upper first plate 1100, and the upper movement bar 2010 is maximally accommodated within the upper first plate 2100.

Further, only a portion of a front end portion of the upper movement bar 2010 is arranged beyond a front end portion of the upper first plate 2100.

Meanwhile, the interlock member 2600 is disposed in the first movement guide groove 2021 of the upper movement bar 2010.

A first long side 2201 of the upper second plate 2200 is disposed close to a first long side 2101 of the upper first plate 2100. And, a second long side 2202 of the upper second plate 2200 is spaced apart from a second long side 2102 of the upper first plate 2100.

In this state, when the upper movement bar 2010 is pulled by the third actuation bar 53, a relative horizontal movement between the upper first plate 2100 and the upper second plate 2200 occurs and the window 30 is converted to the closed state.

As illustrated in FIGS. 27 and 28 and FIGS. 29B, 30B, 31B, and 32B, in the closed state of the window 30, the upper movement bar 2010 is moved by the third actuation bar 53 such that the rear end portion of the upper movement bar 1010 enters inside the upper first plate 2100, and the upper movement bar 2010 is minimally accommodated inside the upper first plate 2100.

Further, the front end portion and the middle portion of the upper movement bar 2010 are arranged beyond the front end portion of the upper first plate 2100 by being maximally pulled by the third actuation bar 53.

Meanwhile, the interlock member 2600 is disposed in the second movement guide groove 2022 of the upper movement bar 2010.

Due to the relative movement between the upper first plate 2100 and the upper second plate 2200, the second long side 2202 of the upper second plate 2200 and the second long side 2102 of the upper first plate 2100 are translated to be disposed close to each other, and the first long side 2201 of the upper second plate 2200 is spaced apart from the first long side 2101 of the upper first plate 2100.

In such a relative movement between the upper first plate 2100 and the upper second plate 2200, since the window frame 31 coupled to the upper first plate 2100 moves along with the upper first plate 2100, this ultimately causes a relative movement between the window frame 31 and the upper second plate 2200, which may cause the opening or closing action of the window 30.

Meanwhile, because an upper end portion of the upper support roller 2510 is disposed to be lower than an upper surface (or a top surface) of the chassis rail, the upper support roller 2510 does not contact the upper surface of the chassis rail and thus does not impede the movement.

As such, when the upper horizontal movement module 2000 and the lower horizontal movement module 1000 are in the open state, the window frame 31 are spaced apart from the side surface of the chassis 20 and can move freely, as shown in FIG. 3.

In contrast, when the upper horizontal movement module 2000 and the lower horizontal movement module 1000 are in the closed state, the window frames 31 are in tight contact with the side surface of the chassis 20, as shown in FIG. 4, and thus can be sealed by eliminating the separation space.

In the present invention, the upper horizontal movement module 2000 and the lower horizontal movement module 1000 are installed on the upper and lower portions of the window 30, respectively. In the case of the lower horizontal movement module 1000, the groove of the movement roller 1410 is inserted by the center rail and the position thereof is fixed, so that the lower horizontal movement module 1000 does not swing from side to side with respect to the entire rail (i.e., a space formed by the center rail and both sidewalls of the center rail), along with the lower plate 1100 and the movement roller 1410, and the lower support roller 1510.

In this case, the lower support rollers 1510 are in contact with both sidewalls of the rail, but even if they are in contact, they do not interfere with the slide movement of the window because each of the lower support rollers 1510 is small compared to the conventional large horizontal rollers, so that the rotation can be smoothly accomplished with a small friction force.

Further, in the upper horizontal movement module 2000, the upper support rollers 2510 are also in contact with both sidewalls of the rail, and even if they are in contact, they do not interfere with the slide movement of the window because each of the upper support rollers 2510 is small compared to the conventional large horizontal rollers, so that rotation can be smoothly accomplished with a small friction force.

Moreover, the support forces of the lower support rollers 1510 and the upper support rollers 2510 against both sidewalls of the rail may allow the window to remain upright and unshakeable about X-axis direction (i.e., an axial direction along which the window slides).

The horizontal movement module according to the present invention has the technical advantages as follows.

According to the present invention, the horizontal movement module includes the upper horizontal movement module and the lower horizontal movement module and thus stably causes and guides the horizontal movement of the window at the upper and lower portions.

The horizontal movement module for the horizontal movement window includes the movement bar with the movement guide groove, the first plate on which the movement bar is placed, the second plate that moves relative to the first plate in coordination with the movement of the movement bar, and the roller module on the second plate, and thus has the advantage of guiding the perpendicular movement in the horizontal direction via the movement roller rotating about the horizontal shaft and preventing the rotation on the horizontal plane of the second plate by contacting with the lateral counterpart via the support roller rotating about the oblique shaft having the inclination angle to the virtual vertical axis.

In the horizontal movement module, the movement bar is disposed in the longitudinal direction of the first plate, the resting groove for the movement bar and the opening are provided in the first plate, the interlocking member interlocking the movement bar guide groove with the second plate is included, and the second plate is formed with the hole to which the interlock member passing through the opening while being fitted into the movement guide groove of the movement bar, is coupled, so as to have the advantage of effectively interlocking the movement between the movement bar and the second plate.

As the movement guide groove includes two grooves offset to the first side and the second side with respect to the longitudinal centerline of the movement bar and the third groove connecting these two grooves, it has the advantage of implementing the specific movement pattern.

Such two grooves are formed parallel to the centerline of the movement bar, and the third groove is arranged to intersect the centerline at then oblique angle, they have the advantages of providing the simple yet effective interlocking movement.

The horizontal movement module further includes the movement inducing member connecting portion for transmitting the external force for moving the movement bar, which has the advantage of facilitating the connection with the external operating mechanism.

The horizontal movement module further includes the roller module coupling portion on the lower portion of the second plate, and allows the oblique shaft of the support roller to be connected to the lower surface of the coupling portion. Such a configuration has the advantage of enabling the stable mounting and support of the roller module.

In the horizontal movement module, the plurality of support rollers are arranged in the longitudinal and lateral directions to have the advantage of effectively preventing the horizontal movement module from rotating from side to side on the horizontal plane during the horizontal movement of the horizontal movement module or during the movement in the chassis.

In the horizontal movement module, the outer surface of the support roller is arranged to be perpendicular to the horizontal plane in the upward and downward directions to continuously contact the counterpart, thereby having the advantage of realizing the line contact, which increases the contact support stability, compared to the point contact.

In the horizontal movement module, the second plate is fitted in the lower portion of the first plate, the guide groove to guide the relative movement is provided, and the step is provided on the second plate to be fitted in the guide groove, thereby having the advantage of inducing the stable relative movement between the first and second plates.

In summary, the present invention focuses on preventing the rotation of the module in the horizontal movement window, efficiently interlocking the movement mechanism, and providing the stable support to improve the operation performance.

Further, via the simplification of the structure, the present invention has the advantage of improving the productivity, reducing the processing costs and time, and reducing the need to replace the components due to wear.

In particular, the multiple arrangement of the support rollers and the line-contact structure are key features that greatly improve the horizontal movement stability.

In addition, by eliminating the use of curved guide grooves formed in a specific direction on the plate, the convenient assembly and the easy maintenance are secured.

Although a number of examples have been described, it should be understood that other modifications and implementations can be devised by those skilled in the art that will fall within the spirit and scope of the principles of the present invention. More particularly, various variations and modifications in the structure or the configuration are possible within the scope of the disclosure, the drawings, and the appended claims. In addition to variations and modifications in the configuration, alternative uses will also be apparent to those skilled in the art.

What is claimed is:

1. A horizontal movement module for a horizontal movement window comprising:
a movement bar having a movement guide groove;
a first plate on which the movement bar is seated;
a second plate disposed to be opposite to the movement bar with respect to the first plate and configured to be moved relative to the first plate in coordination with a movement of the movement bar; and
a roller module provided on the second plate,
wherein the roller module includes a support roller configured to rotate about an oblique shaft having an inclination angle with respect to a virtual vertical axis and to contact a lateral counterpart to prevent a rotation of the second plate on a horizontal plane.

2. The horizonal movement module of claim 1, further comprising a roller module coupling portion provided at a lower portion of the second plate and allowing the roller module to be coupled thereto, wherein on a lower surface of the roller module coupling portion, the oblique shaft of the support roller is connected.

3. The horizonal movement module of claim 1, wherein the roller module includes a plurality of support rollers provided in a longitudinal direction and a lateral direction.

4. The horizonal movement module of claim 1, wherein an outer surface of the support roller is configured to be perpendicular to the horizontal plane in upward and downward directions, such that the counterpart and the outer surface of the support roller are continuously contacted with each other in the upward and downward directions.

5. The horizonal movement module of claim 1, wherein the movement bar is disposed in a longitudinal direction of the first plate,
the first plate is provided with a resting groove in which the movement bar is seated, and
the resting groove is provided with an opening, and
wherein the movement bar includes an interlock member that interlocks the movement guide groove of the movement bar with the second plate, and
the second plate is formed with an interlock member coupling hole to which the interlock member passing through the opening while being fitted into the movement guide groove provided in the movement bar, is coupled.

6. The horizonal movement module of claim 1, wherein the movement guide groove includes:
a first movement guide groove configured to be offset toward a first side with respect to a centerline in a longitudinal direction of the movement bar;
a second movement guide groove configured to be offset toward a second side which is opposite to the first side; and
a third movement guide groove configured to connect the first movement guide groove and the second movement guide groove.

7. The horizonal movement module of claim 6, wherein the first movement guide groove and the second movement guide groove are formed parallel to the centerline in the longitudinal direction of the movement bar, and the third movement guide groove is arranged to cross the centerline in the longitudinal direction of the movement bar while forming a predetermined oblique angle with respect to the centerline.

8. The horizonal movement module of claim 6, further comprising a movement inducing member connecting portion which is provided to the movement bar and allows a movement inducing member providing to the movement bar an external force for moving the movement bar, to be connected thereto.

9. A horizontal movement module for a horizontal movement window comprising:
a movement bar having a movement guide groove;
a first plate on which the movement bar is seated;
a second plate disposed to be opposite to the movement bar with respect to the first plate and configured to be moved relative to the first plate in coordination with a movement of the movement bar; and
a roller module provided on the second plate,
wherein the roller module includes:
a movement roller configured to rotate about a horizontal shaft and to guide a movement perpendicular to the horizontal shaft in a horizontal direction; and
a support roller configured to rotate about an oblique shaft having an inclination angle with respect to a virtual vertical axis and to contact a lateral counterpart to prevent a rotation of the second plate on a horizontal plane.

10. The horizonal movement module of claim 9, wherein the movement bar is disposed in a longitudinal direction of the first plate,
the first plate is provided with a resting groove in which the movement bar is seated, and
the resting groove is provided with an opening, and
wherein the movement bar includes an interlock member that interlocks the movement guide groove of the movement bar with the second plate, and
the second plate is formed with an interlock member coupling hole to which the interlock member passing through the opening while being fitted into the movement guide groove provided in the movement bar, is coupled.

11. The horizonal movement module of claim 9, wherein the movement guide groove includes:
a first movement guide groove configured to be offset toward a first side with respect to a centerline in a longitudinal direction of the movement bar;
a second movement guide groove configured to be offset toward a second side which is opposite to the first side; and
a third movement guide groove configured to connect the first movement guide groove and the second movement guide groove.

12. The horizonal movement module of claim 11, wherein the first movement guide groove and the second movement guide groove are formed parallel to the centerline in the longitudinal direction of the movement bar, and the third movement guide groove is arranged to cross the centerline in the longitudinal direction of the movement bar while forming a predetermined oblique angle with respect to the centerline.

13. The horizonal movement module of claim 11, further comprising a movement inducing member connecting portion which is provided to the movement bar and allows a movement inducing member providing to the movement bar an external force for moving the movement bar, to be connected thereto.

14. The horizonal movement module of claim 9, further comprising a roller module coupling portion provided at a lower portion of the second plate and allowing the roller module to be coupled thereto, wherein on a lower surface of the roller module coupling portion, the oblique shaft of the support roller is connected.

15. The horizonal movement module of claim 9, wherein the roller module includes a plurality of support rollers provided in a longitudinal direction and a lateral direction.

16. The horizonal movement module of claim 9, wherein an outer surface of the support roller is configured to be perpendicular to the horizontal plane in upward and downward directions, such that the counterpart and the outer surface of the support roller are continuously contacted with each other in the upward and downward directions.

17. The horizonal movement module of claim 9, wherein the second plate is inserted into a lower portion of the first plate,
a guide groove is provided to the lower portion of the first plate to guide a relative movement between the first plate and the second plate, and
a guide step is provided at the second plate to be inserted into the guide groove.
